(19) United States
(12) Patent Application Publication
(10) Pub. No.: US 2011/0079454 A1
(43) Pub. Date: Apr. 7, 2011

(54) HYBRID VEHICLE CONFIGURATION AND METHOD OF RECONFIGURING NON-HYBRID VEHICLE ARCHITECTURE AS HYBRID VEHICLE ARCHITECTURE

(75) Inventors: Joel M. Maguire, Northville, MI (US); Shawn H. Swales, Canton, MI (US); John Czubay, Troy, MI (US); Norman Schoenek, Novi, MI (US)

(73) Assignee: GM GLOBAL TECHNOLOGY OPERATIONS, INC., Detroit, MI (US)

(21) Appl. No.: 12/574,848

(22) Filed: Oct. 7, 2009

(51) Int. Cl. B60K 6/48; B23P 17/00

(52) U.S. Cl. 180/65.25; 29/401.1; 180/65.21

(57) ABSTRACT

A hybrid vehicle has an engine, and a transmission having a transmission input member operatively connected to the engine and a transmission output member. A transfer case is operatively connected to the transmission output member and has a first and a second transfer case torque distribution member, each operable to distribute torque from the transmission output member. The first transfer case torque distribution member is operatively connected with one of the front and rear pairs of wheels for providing driving torque from the transmission output member to the one of the front and rear pairs of wheels. A propeller shaft extends from and is operatively connected at one portion to the second transfer case distribution member. A motor/generator is operatively connected to another portion of the propeller shaft.

### TECHNICAL FIELD

The present invention relates to hybrid vehicle configurations.

### BACKGROUND OF THE INVENTION

Automotive hybrid powertrains typically have an engine and one or more motor/generators interconnected by transmission gearing and selectively engagable torque-transmitting mechanisms controlled to provide various vehicle operating modes, such as one or more electrically-variable modes of operation, fixed speed ratio modes, and an electric-only (battery-powered) mode. Hybrid powertrains may improve vehicle fuel economy in a variety of ways, primarily by using one or both of the motor/generators for vehicle braking and using the regenerated energy to power the vehicle electrically, with the engine off. The engine may be turned off at idle, during periods of deceleration and braking, and during periods of low speed or light load operation to eliminate efficiency losses due to engine drag. Braking energy captured via regenerative braking (or electrical energy generated during periods when the engine is operating) is utilized during these engine-off periods. Transient demand for engine torque or power is supplemented by the motor/generators during operation in engine-on modes, allowing for a smaller engine without reducing vehicle performance. Additionally, the electrically-variable modes may allow the engine to be operated at or near the optimal efficiency point for a given power demand.

### SUMMARY OF THE INVENTION

Hybrid powertrain configurations are provided that require minimal reconfiguration of non-hybrid configurations, thus offering the fuel economy benefits of various operating modes while containing overall cost of designing and implementing hybrid vehicle platforms. Specifically, a hybrid vehicle is provided with a pair of front wheels and pair of rear wheels, an engine, and a transmission having a transmission input member operatively connected to the engine and a transmission output member. A transfer case is operatively connected to the transmission output member and has a first and a second transfer case torque distribution member, each operable to distribute torque from the transmission output member. The first transfer case torque distribution member is operatively connected with one of the front and rear pairs of wheels for providing driving torque from the transmission output member to the one of the front and rear pairs of wheels. A propeller shaft extends from and is operatively connected at one portion to the second transfer case distribution member. A motor/generator is operatively connected to another portion of the propeller shaft and is operable to function as a motor and as a generator to provide driving torque to or receive torque from the one of the front and rear pairs of wheels via the propeller shaft and the transfer case. Preferably, the vehicle is characterized by the absence of a differential and the absence of axles operatively connecting the propeller shaft to the other of the front and rear pairs of wheels, and the motor/generator is installed in a packaging space that would otherwise be occupied by such a differential and axles on a non-hybrid vehicle configuration. A power electronics module connecting a battery for powering the motor/generator is preferably mounted to the motor/generator, eliminating power cables connecting the power electronics to the motor/generator. Alternatively, the power electronics module may be mounted proximate the motor/generator to minimize the required length of power cables.

A method of reconfiguring a non-hybrid vehicle architecture includes operatively connecting a motor/generator to the propeller shaft in lieu of the differential and the drive axles to thereby reconfigure the non-hybrid vehicle architecture to a hybrid architecture with engine-only, electric-only and parallel hybrid operating modes in which torque is provided to only the other of the front and rear pairs of wheels.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of a first embodiment of a transverse front-wheel drive hybrid vehicle;

FIG. 2 is a perspective view of a portion of the hybrid vehicle of FIG. 1;

FIG. 3 is a plan view of a second embodiment of a longitudinal rear-wheel drive hybrid vehicle; and

FIG. 4 is a flowchart of a method of reconfiguring a non-hybrid vehicle architecture as a hybrid vehicle architecture.

### DESCRIPTION OF THE PREFERRED EMBODIMENTS

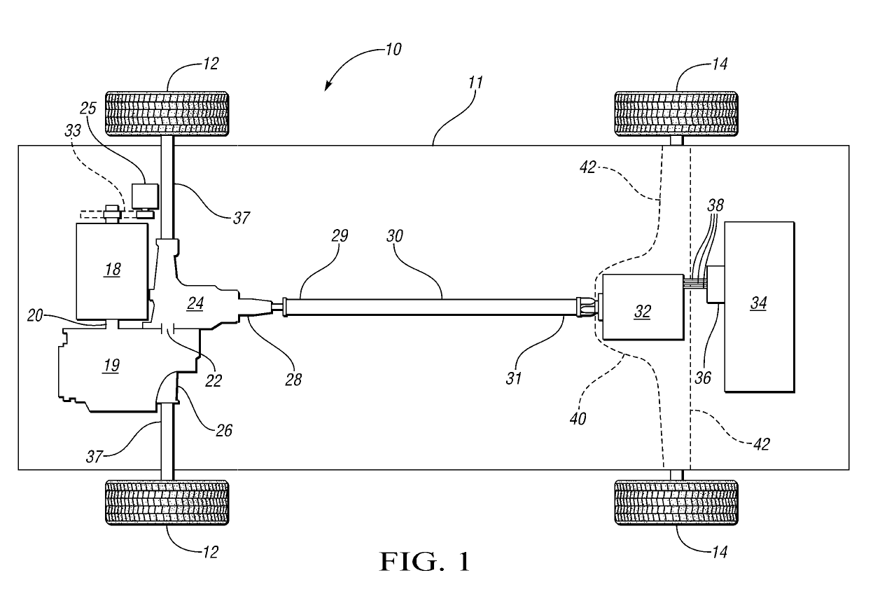

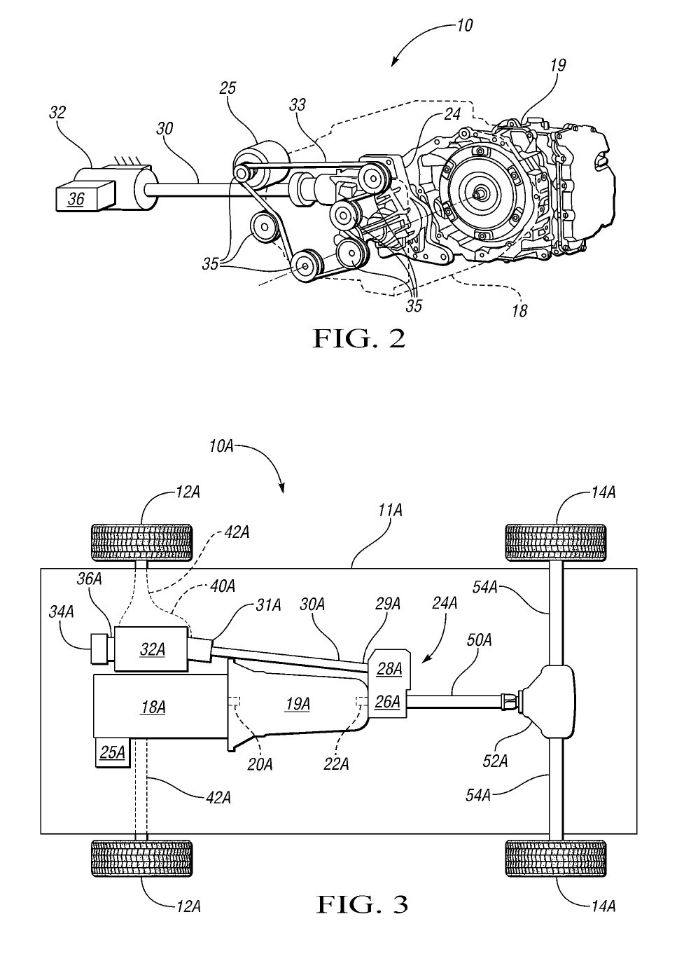

Referring to the drawings, wherein like reference numbers refer to like components, FIG. 1 shows a hybrid vehicle 10 illustrating a first embodiment of hybrid architecture. The hybrid vehicle 10 is represented schematically by a frame 11, but many other frame members not shown run longitudinally and transversely around and between the components shown. The hybrid vehicle 10 has a pair of front wheels 12 and a pair of rear wheels 14. An engine 18 is mounted near the front of the vehicle 10. The engine 18 may be any type of rotary engine including an internal combustion engine, such as a gasoline engine or a diesel engine, or an external combustion engine. The engine 18 is operatively connected to a transmission 19 to provide driving power thereto. The transmission 19 has an input member 20 that receives torque from the engine, and an output member 22 that delivers torque at one or more predetermined ratios to torque at the input member 20, as is known. The transmission input member 20 and transmission output member 22 are shown only schematically, but are well understood by those skilled in the art. A starter motor 25 is operatively connected to the engine 18 for cranking the engine 18. As best shown in FIG. 2, in this embodiment, the starter motor 25 is a belt-alternator starter type motor/generator operatively connected to provide torque to the crankshaft of the engine 18 via a belt 33 and a series of engine mounted pulleys 35, sprockets or gears. Accessory systems, such as an air conditioning system, are driven by the various belt driven pulleys 35. Alternatively, the starter motor 25 may be an automatically-actuated engine-mounted starter motor, such as motor 25A shown and described with respect to vehicle 10A of FIG. 3.

The starter motor 25 has a 36 Volt battery, but is not limited to such. The starter motor 25 is operable for an initial startup of the engine 18, such as to launch the vehicle 10 or after an electric-only launch by motor/generator 32 described below. The starter motor 25 is also controllable so that the engine 18 can be shut down when the vehicle 10 comes to a stop, or during an electric-only operating mode (discussed below), and restarted when operating conditions indicate an engine-only or parallel hybrid operating mode is warranted, referred to as an engine stop/start or auto-start. The starter motor 25 may also be controlled to operate as a generator, capturing braking energy during a regenerative braking mode. Furthermore, the starter motor 25 can be controlled to add torque to or receive torque from the engine crankshaft to smooth torque provided by the engine 18 (i.e., to eliminate spikes in torque from the front axles 37).

The transmission output member 22 is operatively connected to a transfer case 24 that divides the torque provided from the transmission output member between a first transfer case distribution member 26 and a second transfer case distribution member 28, in a predetermined ratio, as is known. Transfer cases are well known mechanisms to deliver torque between different axes of a powertrain. The first transfer case distribution member 26 provides torque to front drive axles 37, and thereby to the front wheels 12.

The second transfer case distribution member 28 is operatively connected to a first portion 29 (e.g., a forward end) of a longitudinally-arranged propeller shaft 30. A second portion 31 (e.g., a rearward end) of the propeller shaft 30 is connected to an electric motor/generator 32. The motor/generator 32 is mounted to the rear frame members of the vehicle, in a rear trunk, or at any location rearward of the propeller shaft 30. An energy storage device, in this case arranged as a battery pack 34, is mounted proximate the motor/generator 32, such as rearward of rear seats of the vehicle 10. A power electronics module 36, including a controller and an inverter is connected to the battery 34 and via relatively short three-phase cables 38 to the motor/generator 32. Alternatively, the battery 34 may be situated so that the power electronics module 36 is directly mounted to the motor/generator 32, eliminating power cables.

Notably, the motor/generator 32 is mounted in approximately the same location and in lieu of a differential 40 and transverse rear axles 42 (shown in phantom) extending from the differential 40 to the rear wheels 14, as would be provided in a non-hybrid vehicle configuration. The packaging space for the differential 40 and transverse drive axles 42 is shown schematically in phantom. Such a differential and transverse axles would provide a four-wheel drive or all-wheel drive mode in a non-hybrid vehicle, in which torque from the engine 18 is distributed to both the front wheels 12 and the rear wheels 14. Thus, rather than the propeller shaft 30 distributing tractive power to the rear wheels 14 via a differential and transverse rear axles, the motor/generator 32 provides torque to the front wheels 12 via the propeller shaft 30 and transfer case 24, or receives torque from the engine 18 via the transfer case 24 and the propeller shaft 30. Accordingly, a transverse, non-hybrid four-wheel drive or all-wheel drive architecture is converted to a transverse, front-wheel drive hybrid vehicle architecture with a single tractive motor 32 with minimal repackaging issues and minimal platform-specific components. As used herein, “transverse” refers to the arrangement of the engine 18 and transmission 19 to provide torque to the front wheels 12.

The vehicle 10 is operable in various operating modes, including an engine-only operating mode in which the engine 18 provides tractive power to the front wheels 12 through the transmission 19 and transfer case 24. The vehicle 10 may be launched either to establish the engine-only operating mode, with starter motor 25 used to start the engine 18 in an initial startup mode, or may be launched by motor/generator 32 in an electric-only operating mode. The electric-only operating mode is established when the engine 18 is stopped and the motor/generator 32 is controlled to function as a motor, using energy stored in the battery 34 to providing tractive power to the front wheels 12 via the propeller shaft 30 and the transfer case 24. A parallel hybrid operating mode is established when the engine 18 is running and the motor/generator 32 adds torque in parallel with the engine 18 to the front wheels 12 via the propeller shaft 30 and the transfer case 24. In order to conserve fuel, the engine 18 may be stopped, such as when waiting at a stop light. The starter motor 25 may then be powered to restart the engine 18, in an engine auto-start mode.

Referring to FIG. 3, an alternative embodiment of a hybrid vehicle 10A is shown. The hybrid vehicle 10A is represented schematically by a frame 11A, but many other frame members not shown run longitudinally and transversely around and between the components shown. The hybrid vehicle 10A has a pair of front wheels 12A and a pair of rear wheels 14A. An engine 18A is mounted near the front of the vehicle 10A. The engine 18A may be any type of rotary engine including an internal combustion engine, such as a gasoline engine or a diesel engine, or an external combustion engine. The engine 18A is operatively connected to a transmission 19A to provide driving power thereto. The transmission 19A has an input member 20A that receives torque from the engine, and an output member 22A that delivers torque at one or more predetermined ratios to torque at the input member 20A, as is known. The transmission input member 20A and transmission output member 22A are shown schematically in phantom. Preferably, the starter motor 25A is a 12 Volt, automatically-actuated starter motor mounted to the engine 18A, as is typical in non-hybrid vehicles. Alternatively, a BAS-type motor/generator may be used, such as is shown and described with respect to the embodiment of FIGS. 1 and 2.

The starter motor 25A is operable for initial startup of the engine 18A, such as to launch the vehicle 10A or after an electric-only launch by motor/generator 32A. The starter motor 25A is also controllable so that the engine 18A can be shut down when the vehicle 10A comes to a stop, or during an electric-only operating mode (discussed below), and restarted when operating conditions indicate an engine-only or parallel hybrid operating mode is warranted, referred to as an engine stop/start or auto-start. Furthermore, the starter motor 25A can be controlled to add torque to the engine crankshaft to smooth torque provided by the engine 18A (i.e., to eliminate spikes in torque delivered to the rear axles 54A).

The transmission output member 22A is operatively connected to a transfer case 24A that divides the torque provided from the transmission output member 22A between a first transfer case distribution member 26A and a second transfer case distribution member 28A, in a predetermined ratio, as is known. Transfer cases are well known mechanisms to deliver torque between different axes of a powertrain. The first transfer case distribution member 26A provides torque via a drive shaft 50A to a rear differential 52A and rear drive axles 54A connected thereto, and thereby to the rear wheels 14.

The second transfer case distribution member 28A is operatively connected to a first portion 29A (e.g., a rearward end) of a longitudinally-arranged propeller shaft 30A. A second portion 31A (e.g., a forward end) of the propeller shaft 30A is connected to an electric motor/generator 32A. The motor/generator 32A is mounted to the front frame members of the vehicle, in the engine compartment, or at any location forward of the propeller shaft 30A. An energy storage device in the form of a battery pack 34A is mounted proximate the motor/generator 32A. A power electronics module 36A, including a controller and an inverter is connected to the battery 34A and directly mounted to the motor/generator 32A, eliminating power cables. Alternatively, relatively short three-phase cables may connect the battery 34A to the motor/generator 32A.

Notably, the motor/generator 32A is mounted in approximately the same location and in lieu of a differential 40A and transverse front axles 42A from the differential to the front wheels 12A that would be connected with the propeller shaft 30A in an all-wheel drive version or four-wheel drive operating mode of a non-hybrid, rear-wheel drive version of vehicle 10A. Such a differential and transverse axles would provide a four-wheel drive or all-wheel drive mode in which torque from the engine 18A is distributed to both the front wheels 12A and the rear wheels 14A. Thus, rather than the propeller shaft 30A distributing tractive power to the front wheels 12A via a differential and transverse rear axles, the motor/generator 32A provides torque to the front wheels 12A via the propeller shaft 30A and transfer case 24A, or receives torque from the engine 18A via the transfer case 24A and the propeller shaft 30A. Accordingly, a longitudinal, non-hybrid four-wheel drive or all-wheel drive architecture is converted to a longitudinal rear-wheel drive hybrid vehicle architecture with a single tractive motor with minimal repackaging issues. As used herein, “longitudinal” refers to the arrangement of the engine 18A and transmission 19A to provide torque to the rear wheels 14A.

The vehicle 10A is operable in various operating modes, including an engine-only operating mode in which the engine 18A provides tractive power to the rear wheels 14A through the transmission 19A, transfer case 24A, drive shaft 50A, differential 52A and rear transfer axles 54A. The vehicle 10A may be launched either to establish the engine-only operating mode, with starter motor 25A used to start the engine 18A, or may be launched by motor/generator 32A in an electric-only operating mode. The electric-only operating mode is established when the engine 18A is stopped and the motor/generator 32A is controlled to function as a motor, using energy stored in the battery 34A to providing tractive power to the rear wheels 14A via the propelled shaft 30A, transfer case 24A, drive shaft 50A, differential 52A and rear transfer axles 54A. A parallel hybrid operating mode is established when the engine 18A is running and the motor/generator 32A adds torque in parallel with the engine 18A to the rear wheels 14A via the propeller shaft 30A, transfer case 24A, drive shaft 50A, differential 52A and rear transfer axles 54A. In order to conserve fuel, the engine 18A may be stopped, such as when waiting at a stop light. The starter motor 25A may then be powered to restart the engine 18A, in an engine auto-start mode.

As discussed above, the hybrid vehicles 10, 10A are designed by reconfiguring a non-hybrid vehicle platform configured to provide four-wheel drive or all-wheel drive operation. Using the transfer case and propeller shaft necessary for such vehicle architectures, the differential and transfer axles generally used to transfer torque to the second set of wheels during four-wheel drive operation are replaced by a motor/generator, battery pack and a power electronics module. Thus, a non-hybrid vehicle platform is easily reconfigured as a hybrid vehicle platform using existing packaging space and powertrain components of a non-hybrid architecture.

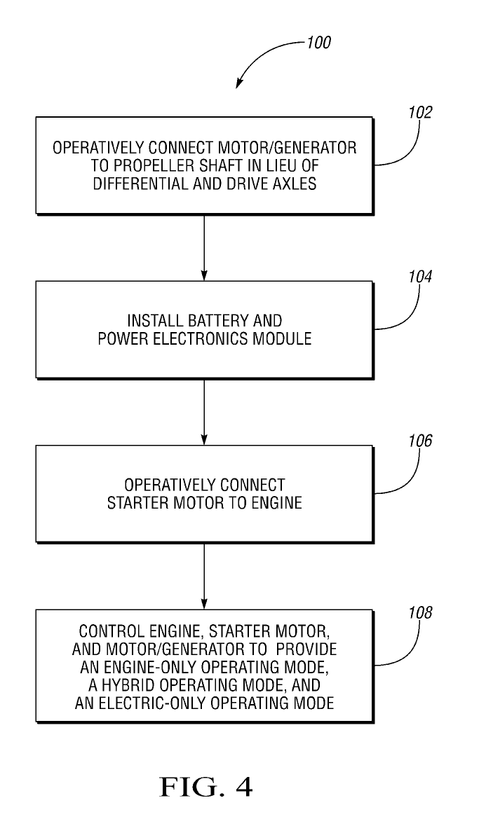

Referring to FIG. 4, a flowchart 100 depicts a method of reconfiguring a non-hybrid vehicle architecture as a hybrid vehicle architecture. The method 100 is described with respect to the vehicle 10, but is equally applicable to vehicle 10A and other embodiments within the scope of the claimed invention. The method 100 includes step 102, operatively connecting a motor/generator 32 to a propeller shaft 30 in lieu of a differential 40 and drive axles 42 that would otherwise be used to establish a four-wheel drive or all-wheel drive operating mode of the non-hybrid vehicle architecture being reconfigured. A battery 34 or battery pack and a power electronics module 36 are installed in step 104, preferably adjacent the motor/generator 32 and with the power electronic module 36 mounted very close to the motor/generator 32 to shorten power cables 38 connecting the battery 34 to the motor/generator 32, or with the power electronics module 36 mounted directly to the motor/generator 32.

In step 106, a starter motor 25 is connected with the engine 18, either as a directly mounted starter motor or in a belt-alternator starter arrangement in which the starter motor is also operable as a generator. Finally, in step 108, controllers (not shown) are provided with control algorithms and operatively connected with the engine 18, starter motor 25, transmission 19 and motor/generator 32 so that the engine 18, starter motor 25 and motor/generator 32 are controlled to provide one or more engine-only operating modes, an electric-only operating mode, a parallel hybrid operating mode, and engine start/stop (auto-start) operating modes, (via separate controllers, such as an engine controller, transmission controller controlling clutches within the transmission, a motor controller and a hybrid controller, or by control modules combining one or more of the functions of such controllers).

While the best modes for carrying out the invention have been described in detail, those familiar with the art to which this invention relates will recognize various alternative designs and embodiments for practicing the invention within the scope of the appended claims.

1. A hybrid vehicle comprising:
a pair of front wheels and a pair of rear wheels;
an engine;
a transmission having a transmission input member operatively connected to the engine and a transmission output member;
a transfer case operatively connected to the transmission output member and having a first and a second transfer case torque distribution member each operable to distribute torque from the transmission output member; wherein the first transfer case torque distribution member is operatively connected with one of the front and rear pairs of wheels for providing driving torque from the transmission output member to the one of the front and rear pairs of wheels;
a propeller shaft extending from and operatively connected at one portion to the second transfer case distribution member; and
a motor/generator operatively connected to another portion of the propeller shaft and operable to function as a motor and as a generator to provide driving torque to or receive torque from the one of the front and rear pairs of wheels via the propeller shaft and the transfer case.

2. The hybrid vehicle of claim 1, further comprising:
a battery; and
a power electronics module mounted to the motor/generator and operable for distributing electrical power between the battery and the motor/generator.

3. The hybrid vehicle of claim 1, further comprising:
a battery;
a power electronics module operatively connected to the battery;
power cables connecting the power electronics module with the motor/generator;
wherein the power electronics module and the power cables are operable for distributing electrical power between the battery and the motor/generator.

4. The hybrid vehicle of claim 1, wherein the vehicle is characterized by the absence of a differential and the absence of axles operatively connecting the propeller shaft to the other of the front and rear pairs of wheels.

5. The hybrid vehicle of claim 1, wherein the first transfer case torque distribution member is operatively connected with the front pair of wheels; and wherein the motor/generator provides torque to the front pair of wheels via the propeller shaft and transfer case, the vehicle thereby being a transverse, front-wheel drive hybrid vehicle.

6. The hybrid vehicle of claim 1, wherein the first transfer case torque distribution member is operatively connected with the rear pair of wheels; and wherein the motor/generator provides torque to the rear pair of wheels via the propeller shaft and transfer case, the vehicle thereby being a longitudinal, rear-wheel drive hybrid vehicle.

7. The hybrid vehicle of claim 1, further comprising:
a starter motor operatively connected to the engine and operable for starting the engine in at least one of an initial startup mode and an auto-start mode.

8. The hybrid vehicle of claim 7, wherein the starter motor is a belt-alternator-starter motor/generator.

9. The hybrid vehicle of claim 7, wherein the starter motor is further operable as a generator in a regenerative braking mode.

10. The hybrid vehicle of claim 7, wherein the starter motor is further operable for providing or receiving torque to smooth torque provided by the engine.

11. A hybrid vehicle comprising:
a pair of front wheels and a pair of rear wheels;
an engine;
a transmission having a transmission input member operatively connected to the engine and a transmission output member;
a transfer case operatively connected to the transmission output member and having a first and a second transfer case torque distribution member each operable to distribute torque from the transmission output member; wherein the first transfer case torque distribution member is operatively connected with the front pair of wheels for providing driving torque from the transmission output member to the front pair of wheels;
a propeller shaft extending from and operatively connected at one portion to the second transfer case distribution member;
a motor/generator operatively connected to another portion of the propeller shaft and operable to function as a motor and as a generator to provide driving torque to or receive torque from the front pair of wheels via the propeller shaft and the transfer case;
a battery; and
a power electronics module operatively connected to the battery and for distributing electrical power between the battery and the motor/generator; wherein the vehicle is characterized by the absence of any additional motor/generator used to provide vehicle traction.

12. A method of reconfiguring a non-hybrid vehicle architecture; wherein the non-hybrid vehicle architecture includes an engine, a transmission operatively connected to the engine, a transfer case for distributing torque from the transmission to both front and rear pairs of vehicle wheels, a propeller shaft operatively connected to the transfer case for distributing the torque to one of the front and rear pairs of wheels via a differential and drive axles, the method comprising:
operatively connecting a motor/generator to the propeller shaft in lieu of the differential and the drive axles to thereby reconfigure the non-hybrid vehicle architecture to a hybrid architecture with engine-only, electric-only and parallel hybrid operating modes in which torque is provided to only the other of the front and rear pairs of wheels.

13. The method of claim 12, further comprising:
installing a battery and a power electronics module operatively connecting the battery with the motor/generator.

14. The method of claim 12, further comprising:
operatively connecting a starter motor to the engine.

15. The method of claim 12, further comprising:
controlling the engine, the starter motor and the motor/generator to provide the engine-only, electric-only, parallel hybrid and engine start/stop operating modes.
